(19) United States
(12) Patent Application Publication
(10) Pub. No.: US 2015/0189269 A1
(43) Pub. Date: Jul. 2, 2015

(54) RECURSIVE BLOCK PARTITIONING

(71) Applicant: GOOGLE INC., Mountain View, CA (US)

(72) Inventors: Jingning Han, Santa Clara, CA (US); Ronald Sebastiaan Bultje, Mountain View, CA (US)

(73) Assignee: GOOGLE INC., Mountain View, CA (US)

(21) Appl. No.: 14/144,375

(22) Filed: Dec. 30, 2013

(51) Int. Cl. H04N 19/91; H04N 19/593

(52) U.S. Cl. CPC H04N 19/00951; H04N 19/00763

(57) ABSTRACT

In accordance with aspects of the disclosure, systems and methods are provided for dividing an image into regions, applying partition types to each region, determining a rate distortion cost for each region based on partition types applied to each region, determining a coding scheme for each region based on the partition types applied to each region, and separately encoding each region based on the rate distortion cost and coding scheme determined for each region.

### TECHNICAL FIELD

The present description relates to various computer-based techniques for recursive block partitioning and its entropy encoding in video compression.

### BACKGROUND

Generally, video codecs enable compression/decompression of digital video. Typically, there is a complex balance between video quality, quantity of data needed to represent video (i.e., bit rate), complexity of encoding/decoding algorithms, and a number of other factors. Video codecs typically employ block-based coding where larger block sizes render less average overhead cost on coding, while smaller block sizes may allow more flexibility in prediction to reduce residual energy. Conventional video codecs are deficient when handling block size selection to optimize rate distortion cost, while maintaining a relatively simple and concise codec structure. In recent times, a common strategy to optimize a trade-off between average overhead cost and prediction quality is that for a given region, an encoder may test all allowable block sizes and chose one that minimizes rate distortion cost. This common strategy explicitly encodes selected block sizes into a bitstream. Unfortunately, with conventional encoding, such massive searches over all block sizes results in a highly complicated video codec implementation. Further, explicitly coding block size information under-utilizes spatial correlation, which may result in low compression efficiency. As such, there is a need to optimize and/or improve processes by which video codecs are implemented.

### SUMMARY

In accordance with aspects of the disclosure, anon-transitory computer-readable storage medium is provided for storing instructions that when executed cause at least one processor to perform a process. The instructions may include instructions configured to divide an image into a plurality of regions and apply a plurality of partition types to each region of the plurality of regions. The instructions may include instructions configured to determine a rate distortion (e.g., a rate distortion cost) for each region of the plurality of regions based on the plurality of partition types applied to each region of the plurality of regions. The instructions may include instructions configured to determine a coding scheme for each region of the plurality of regions based on the plurality of partition types applied to each region of the plurality of regions. The instructions may include instructions configured to separately encode each region of the plurality of regions based on the rate distortion cost and the coding scheme determined for each region of the plurality of regions.

In accordance with aspects of the disclosure, anon-transitory computer-readable storage medium is provided for storing instructions that when executed cause at least one processor to perform a process. The instructions may include instructions configured to divide a video frame into a plurality of pixel blocks and apply a plurality of partition types to each pixel block of the plurality of pixel blocks. The instructions may include instructions configured to, for a first partition type of the plurality of partition types applied to each pixel block of the plurality of pixel blocks, divide each pixel block of the first partition type into a plurality of pixel sub-blocks, and reapply the plurality of partition types to each pixel sub-block of the plurality of pixel sub-blocks. The instructions may include instructions configured to determine a rate distortion cost for each pixel block and each pixel sub-block based on the plurality of partition types applied and reapplied respectively to each pixel block and each pixel sub-block. The instructions may include instructions configured to determine a coding scheme for each pixel block and each pixel sub-block based on the plurality of partition types applied and reapplied respectively to each pixel block and each pixel sub-block. The instructions may include instructions configured to separately encode each pixel block and each pixel sub-block based on the rate distortion cost and the coding scheme determined for each pixel block and each pixel sub-block.

In accordance with aspects of the disclosure, a system may include at least one processor and memory. The system may include an encoder configured to cause the at least one processor to divide an image into a plurality of regions and apply a plurality of partition types to each region of the plurality of regions. The encoder may be configured to cause the at least one processor to, for at least one partition type of the plurality of partition types applied to each region of the plurality of regions, divide each region of the at least one partition type into a plurality of sub-regions, and reapply the plurality of partition types to each sub-region of the plurality of sub-regions. The encoder may be configured to cause the at least one processor to determine a rate distortion cost for each region and each sub-region based on the plurality of partition types applied and reapplied respectively to each region and each sub-region. The encoder may be configured to cause the at least one processor to determine a coding scheme for each region and each sub-region based on the plurality of partition types applied and reapplied respectively to each region and each sub-region. The encoder may be configured to cause the at least one processor to separately encode each region and each sub-region based on the rate distortion cost and the coding scheme determined for each region and each sub-region.

The details of one or more implementations are set forth in the accompanying drawings and the description below. Other features will be apparent from the description and drawings, and from the claims.

### BRIEF DESCRIPTION OF THE DRAWINGS

FIG. 1A is a block diagram illustrating an example system for implementingvarious computer-based techniques for recursive block partitioning and its entropy encoding in video compression, in accordance with aspects of the disclosure.

FIG. 1B is a block diagram illustrating example components associated with a portion of blocks shown in FIG. 1A, in accordance with aspects of the disclosure.

FIG. 2 is a block diagram illustrating an example encoder, in accordance with aspects of the disclosure.

FIG. 3 is another block diagram illustrating an example decoder, in accordance with aspects of the disclosure.

FIG. 4 is a block diagram illustrating an example technique for recursive block partitioning, in accordance with aspects of the disclosure.

FIG. 5 is a block diagram illustrating an example technique for context-based entropy encoding, in accordance with aspects of the disclosure.

FIG. 6A is a process flow that illustrates a method for producing tables at the encoder, in accordance with aspects of the disclosure.

FIGS. 6B-6C are process flows illustrating example methods for recursive block partitioning, in accordance with aspects of the disclosure.

FIG. 7 is a diagram that illustrates an example of a probability table according to an implementation.

FIG. 8 is a process flow illustrating another example method for recursive block partitioning, in accordance with aspects of the disclosure.

### DETAILED DESCRIPTION

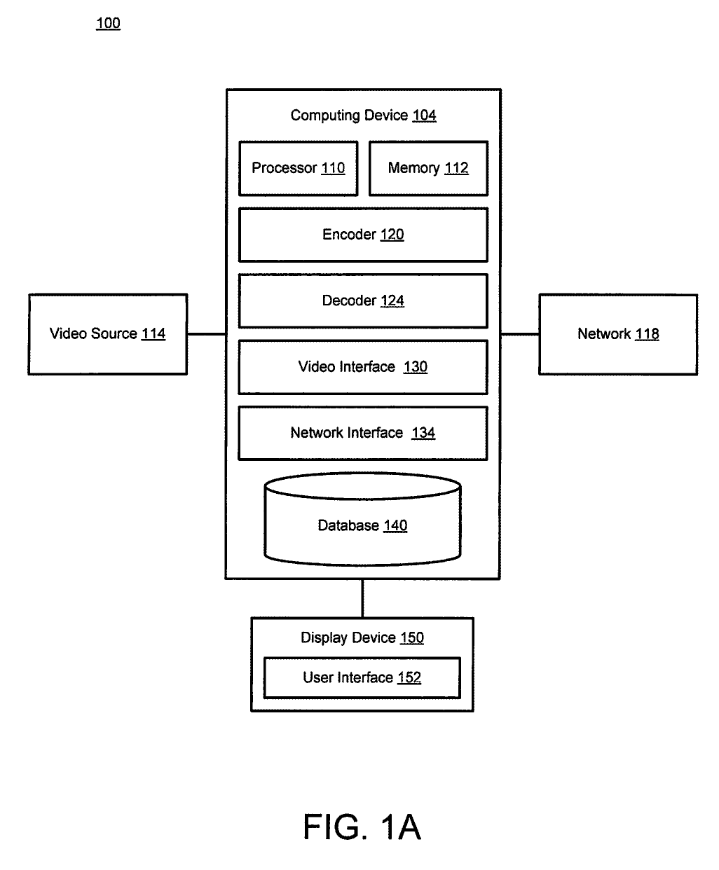

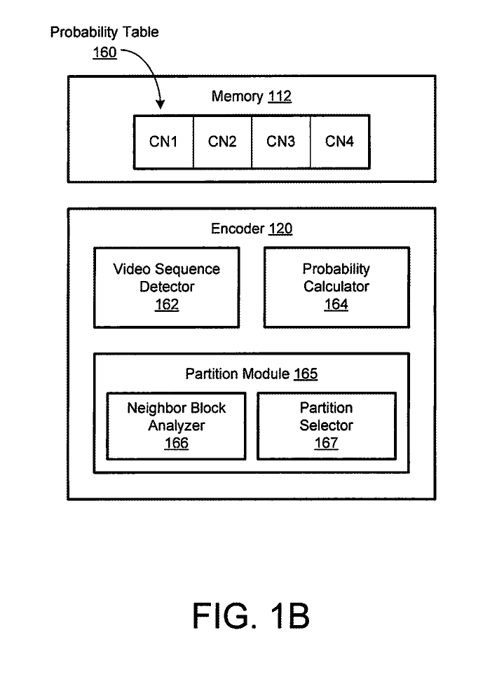

FIG. 1A is a diagram illustrating an example system 100 for implementingvarious techniques for recursive block partitioning and its entropy encoding in video compression, in accordance with aspects of the disclosure. In some implementations, an image may be divided into multiple regions (e.g., each region having a size of n-by-n pixels, such as 64×64 pixels). Further, each region may be tested through a rate distortion loop to find optimal coding decisions (including the manner in which the image is divided or partitioned into regions or pixel block sizes, a prediction mode per block, a transform type applied to each block, etc.), and then each region may be coded or encoded into bitstream in raster order. In some implementations, an image may be divided into multiple regions having a size of n-by-m pixels, such as 64×32 pixels.

The rate distortion loop may be used for improving video quality in video compression and may involve comparing and determining an amount of distortion (loss of video quality) against an amount of data used to encode a video (data rate). In some implementations, the rate distortion loop may be used to improve encoding where decisions may simultaneously affect a file size and quality of an encoded video.

In the example of FIG. 1A, the system 100 may include a computer system for implementing recursive block partitioning. In the example of FIG. 1A, the encoder 120 may include one or more stages to perform various functions in a forward path to provide an encoded or compressed bitstream using an input video stream. As further described herein, an image or video frame of an input video stream may be divided into multiple regions, where each region may be tested or evaluated through a rate distortion loop to find optimal coding decisions, and then each region may be encoded into a bitstream in raster order.

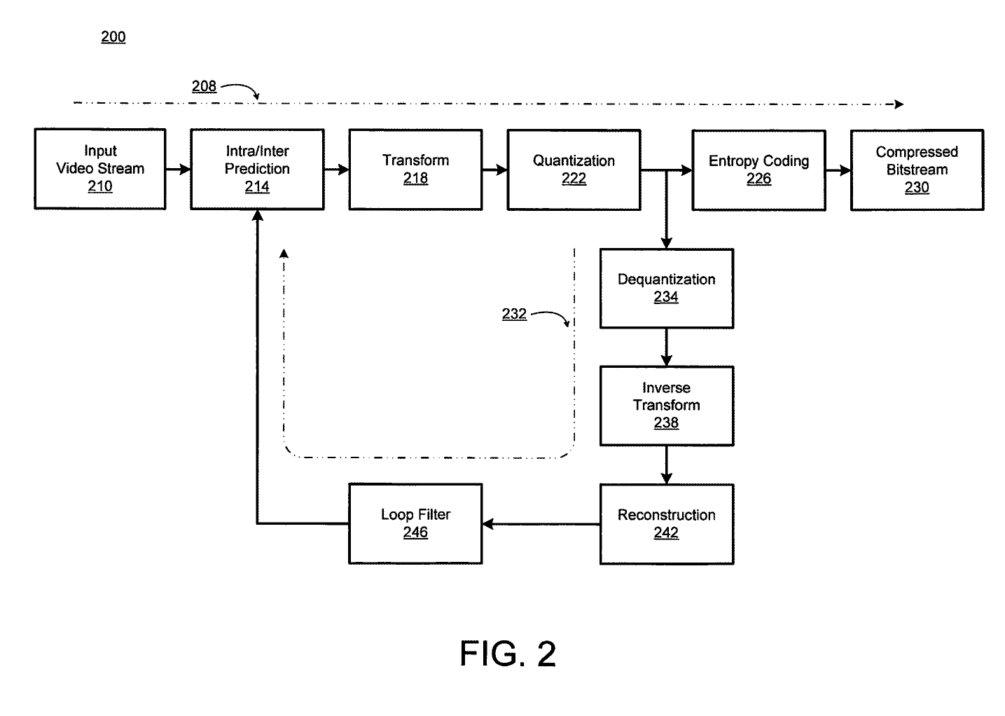

In the example of FIG. 1A, the decoder 124 may include one or more stages to perform various functions to provide an output video stream from an encoded or compressed bitstream. As further described herein, an encoded or compressed bitstream may be provided to the decoder for decoding to provide an output video stream. In some implementations, the decoder 124 is a complement of the encoder 120, whereby a decoding process used by the decoder 124 is a complement of an encoding process used by the encoder 120. More details related to the operation of the encoder 120 and decoder 124 are described below in connection with, for example, FIGS. 2 through 5.

In the example of FIG. 1A, the computing device 104 may include a server or user device in communication with a video source 114 and a network 118. In some implementations, the computing device 104 may be configured to receive a video data stream from the video source 114 via a video interface 130, encode the video data stream via an encoder 120, and transmit the encoded video data stream over the network 118 via a network interface 134. The encoder 120 may use encoding processes that are optimized based on block partitioning and its entropy encoding of the video source 114. Example encoding process(es) by which optimization occurs is described further herein.

In some implementations, the computing device 104 may be configured to receive a video data stream from the network 118 via the network interface 134, decode the video data stream via a decoder 124, and display the decoded video data stream on the display device 150 via the video interface 130. The decoder 124 may use decoding processes that are optimized based on block partitioning and its entropy decoding of the video data stream. Example decoding process(es) are described further herein.

The video source 114 may be any device capable of providing, capturing, and/or transmitting video images, including still images, video frames, etc. For instance, the video source 114 may include a computer server, a laptop computer, a notebook computer, a tablet computer, a mobile phone, a personal digital assistant, a digital camera, a digital camcorder, a webcam, or any other device capable of providing, capturing, and/or transmitting images, including video images. In some implementations, the computing device 104 may receive audio and/or video from multiple video sources 114, and combine the sources into a single video data stream.

In some implementations, the computing device 104 may be at one node of the network 118 and may be operative to directly and indirectly communicate with one or more other nodes of the network 118. For instance, the computing device 104 may include a web server that is operative to communicate with one or more client devices via the network 118 such that the computing device 104 uses the network 118 to transmit and display information to a user on the display device 152. While concepts and techniques described herein are generally described in reference to the computing device 104, various aspects of the disclosure may be applied to any device and/or computing node capable of implementing encoding/decoding operations.

In some implementations, the system 100 may be configured to provide privacy protection for data including, for instance, anonymization of personal identifiable information, aggregation of data, filtering of sensitive information, encryption, hashing or filtering of sensitive information to remove personal attributes, time limitations on storage of information, and/or limitations on data use or sharing. As such, data may be anonymized and aggregated such that individual user data is not revealed.

In the example of FIG. 1A, the video interface 130 may be configured to provide a hardware and/or software interface for input related to many different audio and video standards, which define types of physical characteristics and parameters specified for connections between computing devices, peripherals, and various types of electrical equipment. These audio and video standards may define analog and digital video data transfer protocols for a successful transfer of signals. For instance, a digital interface may be used to connect a video source to a computing device, such as a computer, for transfer of digital video content, such as an input video stream. In some instances, the video interface 130 may be designed to receive an input video stream from the video source 114 and provide it to the encoder 120 for encoding.

In the example of FIG. 1A, the network interface 134 may be configured to manage transmitting video data streams as encoded by the encoder 120. Further, the network interface 134 may be configured to manage receiving video data streams as decoded by the decoder 124. The network interface 134 may be configured to receive instructions from the at least one processor 110 to configure network parameters and network protocols for transmitting and receiving video data streams.

The network 118 may include various configurations and use various protocols including the Internet, World Wide Web, intranets, virtual private networks, local Ethernet networks, private networks using communication protocols proprietary to one or more companies, cellular and wireless networks (e.g., Wi-Fi), instant messaging, hypertext transfer protocol (“HTTP”), simple mail transfer protocol (“SMTP”), and various combinations of the foregoing. Further, the system 100 may be part of a larger system of connected computers that are in communication via the network 118.

Although certain advantages are obtained when information is transmitted or received as noted above, other aspects of the system and method described herein are not limited to any particular manner of transmission of information. For instance, in some implementations, information may be sent via a medium, such as an optical disk or portable drive. In other implementations, the information may be transmitted in a non-electronic format and/or manually entered into the system.

In the example of FIG. 1A, the system 100 may include a computer system for implementing recursive block partitioning that may be associated with a computing device 104 that may be configured as a special purpose machine designed to implement various computer-based techniques for recursive block partitioning and its entropy encoding in video compression, as described herein. In this sense, the computing device 104 may include any standard element(s) and/or component(s), including at least one processor 110, at least one memory 112 (e.g., non-transitory computer-readable storage medium), at least one database 140, power, peripheral(s), and various other computing elements and/or components that may not be specifically shown in FIG. 1A. Further, the system 100 may be associated with a display device 150 (e.g., a monitor or other display) that may be used to provide a user interface (UI) 152, such as, for example, a graphical user interface (GUI). The UI 152 may be used to receive input from a user utilizing the system 100.

As such, various other elements and/or components of the system 100 that may be useful to implement the system 100 may be added or included. Further, in various implementations, the computing device 104 may include any type of device, such as a computer server, a laptop computer, a notebook computer, a tablet computer, a mobile phone, a personal digital assistant, or any other device capable of processing (e.g., encoding, decoding, etc.) and/or transmitting images, including still images and video images.

Although FIG. 1A functionally illustrates the at least one processor 110 and the at least one memory 112 within a single functional block, it should be understood that the at least one processor 110 and the at least one memory 112 may include multiple processors and memories that may or may not be stored within a same physical housing. As such, references to processor(s), computer(s), and/or memory(ies) may include references to a collection of processors, computers, and/or memories that may or may not operate in parallel.

In the example of FIG. 1A, the system 100 may include the computing device 104and instructions recorded on the computer-readable medium 112 and executable by the at least one processor 110. Further, in an implementation, the system 100 may include the display device 150 for providing output to a user, and the display device 150 may include the UI 152 for receiving input from the user.

In the example of FIG. 1A, it should be appreciated that the system 100 is illustrated using various functional blocks or modules that represent more-or-less discrete functionality. However, such illustration is provided for clarity and convenience, and thus, it should be appreciated that the various functionalities may overlap or be combined within a described block(s) or module(s), and/or may be implemented by one or more block(s) or module(s) not specifically illustrated in the example of FIG. 1A. As such, it should be appreciated that conventional functionality that may be considered useful to the system 100 of FIG. 1A may be included as well even though such conventional elements are not illustrated explicitly, for the sake of clarity and convenience.

FIG. 1B is a block diagram illustrating example components associated with a portion of the blocks shown in FIG. 1A, in accordance with aspects of the disclosure. In particular, FIG. 1B illustrates example components associated with the memory 112 and the encoder 120 as shown in FIG. 1A.

In the example of FIG. 1B, the memory 112 may include a probability table 160 with each probability table 160 being associated and/or populated with one or more probability values (e.g., CN1, CN2, CN3, CN4). In various implementations, the memory 112 may include any number of probability tables such as probability table 160 and any number of associated probability values. In some implementations, one or more of the probability values may be related to one or more other probability tables (not shown). One or more of the probability values included in the probability table 160 may be modified/updated for each frame in a video sequence including a set of video frames. The probability values CN1, CN2, CN3, CN4 can each be associated with a probability of a particular partition type being used in conjunction with encoding a block within a video frame.

Further, in the example of FIG. 1B, the encoder 120 may include one or more components (e.g., processing components) including a video sequence detector 162, a probability calculator 164, and a partition module 165. In some implementations, each video frame of a video sequence may be divided into a grid of small regions, where every region may be tested through a rate-distortion optimization loop to find optimal coding decisions, and then coded into bitstream in a raster order.

The video sequence detector 162 may be configured to identify a first frame in a sequence of video frames. For instance, the video sequence detector 162 may be configured to detect a new video sequence, reset/restart probability calculations, and update/modify probability tables including, e.g., reset probability tables to default at a beginning (first frame) of a video sequence. In some implementations, the video sequence detector 162 may be configured to change probability distribution numbers and/or values when detecting a first frame of a video sequence.

The probability calculator 164 may be configured to modify/update a probability value (e.g., probability value CN1) associated with a partition type to an updated probability value based on encoding of the first frame (or subsequent frame) in the sequence of video frames. In some implementations, the probability values of each probability table 160 may be modified/updated to optimize coding decisions for each frame in a video sequence.

The partition module 165 may be configured to encode the first frame in the sequence of video frames based on the probability table 160 stored in the memory 112. In some implementations, the probability table 160 may include one or more probability values associated with one or more partition types. Further, the partition module 165 may be configured to encode a second frame in the sequence of video frames based on updated probability values included in the probability table 160. In some implementations, each frame may be recursively encoded to determine optimal coding decisions, including the manner in which each frame is partitioned into smaller block sizes, the prediction mode per block, the transform type applied to each block, etc.

The partition module 165 may include one or more components including a neighbor block analyzer 166 and a partition selector 167. In some implementations, the neighbor block analyzer 166 may be configured to identify neighboring blocks including a left neighboring block and an above neighboring block (and/or different neighbors), and the partition selector 167 may be configured to apply various partition types to one or more neighboring blocks for further analysis including identifying optimal partitioning of a current block in referent to partitioning of neighboring blocks.

In accordance with aspects of the disclosure, the encoder 120 may be configured to utilize a context-based entropy coding approach to analyze neighboring blocks and select a partition type to optimize coding decisions. For instance, probability models for partition type coding may be conditioned on one or more of the following factors: a current block size (e.g., 64×64, 32×32, 16×16, 8×8, 4×4, 2×2, etc.), a partition type of an above neighboring block, and a partition type of a left neighboring block. Each conditional probability model may be backward adaptive and may be updated on a per-frame basis. This context-based entropy coding technique may be used to efficiently exploit spatial correlation, where partition types tend to be consistent in consecutive areas, and may be used to achieve various performance gains.

Unlike a conventional massive search approach over all possible block sizes, the context-based entropy coding technique of the disclosure is configured to use recursive block partitioning for optimal rate-distortion search and optimal encoding and decoding processes. During a rate-distortion optimization phase, every region/block may be tested through multiple partition types, such as, for example, vertical (vert) partition, horizontal (horz) partition, no partition (none), and split (split) partition into smaller regions/blocks. Further, each of the resulting sub-blocks are then independently tested over various possible prediction modes, filter types, transform sizes, etc., to find their (locally) optimal coding decisions. These and various other aspects of the disclosure are described in greater detail herein.

FIG. 2 is a block diagram illustrating an example encoder 200, in accordance with aspects of the disclosure. The encoder 200 may be implemented in a computing device, a server, a transmitting station, etc., such as by providing a computer software program stored in memory, for example, memory 112 (shown in FIG. 1A). The encoder 200 may include one or more stages to perform various functions in a forward path 208 (e.g., as shown by a dotted flow line) to provide an encoded or compressed bitstream 230 using an input video stream 210. In various implementations, the forward path 208 may include the input video stream 210 as input to the encoder 200 followed by an intra/inter prediction stage 214 (e.g., prediction signals may be subtracted from an original video signal to produce residuals for next stages), a transform stage 218, a quantization stage 222, and an entropy encoding stage 226.

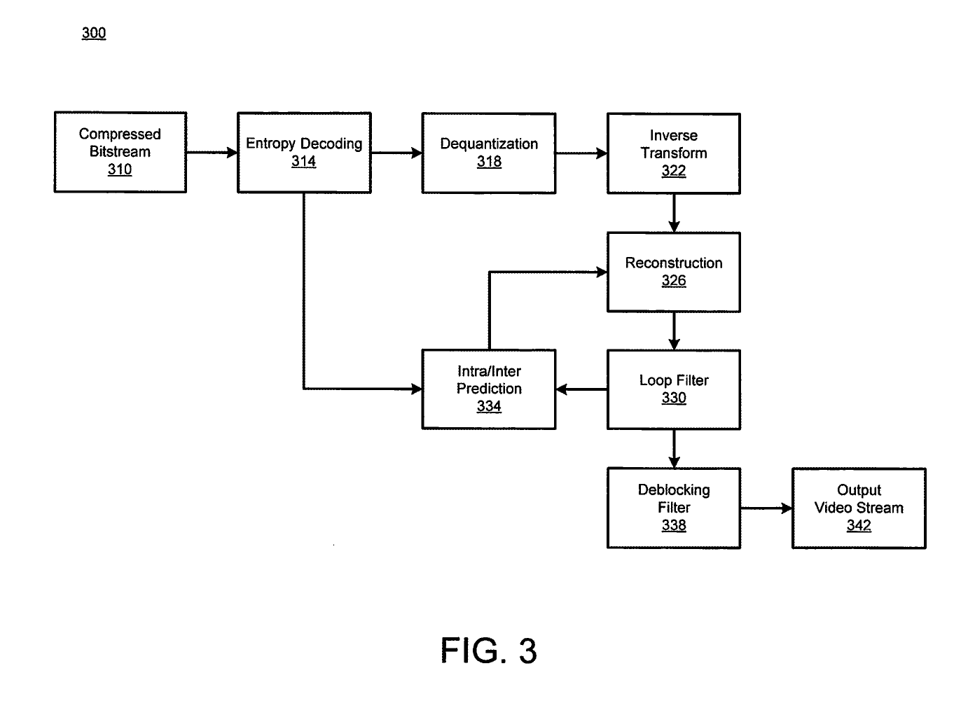

The encoder 200 may include a reconstruction path 232 (e.g., as shown by a dotted connection line) to reconstruct a frame for encoding of future blocks. In some implementations, this may ensure that both the encoder 200 and a decoder 300 (e.g., as shown in FIG. 3) use a same reference to decode the encoded or compressed bitstream 230 provided by the encoder 200. As shown in FIG. 2, the encoder 200 may include one or more additional stages to perform various functions in the reconstruction path 232. In various implementations, the reconstruction path 232 may include a dequantization stage 234, an inverse transform stage 238, a reconstruction stage 242, and a loop filtering stage 246. In other implementations, structural variations of the encoder 200 may be used to encode the input video stream 210.

When the input video stream 210 is sent to the encoder 200 for encoding, each frame of the input video stream 210 may be processed in units of blocks. In some implementations, at the intra/inter prediction stage 214, each block may be encoded using intra-frame prediction (which may be referred to as intra prediction) or inter-frame prediction (which may be referred to as inter prediction). In any case, a prediction block may be formed (e.g., defined). In a case of intra prediction, a prediction block may be formed from samples in a current frame that has been previously encoded and reconstructed. In a case of inter prediction, a prediction block may be formed from samples in one or more previously constructed reference frames. The prediction block may be subtracted from the current block at the intra/inter prediction stage 214 to provide a residual block (which may be referred to as a residual). The transform stage 218 may be configured to transform the residual into transform coefficients in, for instance, a frequency domain.

Further, in some implementations, the quantization stage 222 may be configured to convert the transform coefficients into discrete quantum values, which may be referred to as quantized transform coefficients, using a quantizer value or a quantization level. The quantized transform coefficients may then be entropy encoded by the entropy encoding stage 226. The entropy-encoded coefficients, together with other information used to decode the block, which may include, for instance, the type of prediction used, motion vectors and quantizer value, are then output to the encoded or compressed bitstream 230. In various implementations, the compressed bitstream 230 may be formatted using various techniques, such as, for instance, variable length coding (VLC), arithmetic coding, etc. The compressed bitstream 230 may also be referred to as an encoded video stream or encoded output video stream. The entropy encoding stage 226 may be configured to generate one or more probability tables and generate one or more probability values to populate the probability tables in a manner as described herein.

In some implementations, video codecs may employ block-based coding, where each frame is partitioned into a grid of blocks, each then independently coded using inter/intra-frame prediction followed by spatial transform and quantization. A large block size may result in less average overhead costs on coding the prediction mode, reference frame index, motion vectors, etc., while a small block size may allow more flexibility in prediction, hence reducing the residual energy. Aspects of the disclosure may be configured to provide methods and apparatus to efficiently handle block size selection to optimize an overall rate distortion cost trade-off, while maintaining relatively simple and concise codec structure. Further, a complementary entropy coding technique is provided in the encoder 200 to code/encode each selected block size to fully exploit spatial correlation for coding performance gains, which is further described herein.

One strategy to optimize or balance a trade-off between average overhead cost and prediction quality is that for a given region, an encoder may test each and every allowable block size and chose at least one block size that minimizes a rate distortion cost. Further, an encoder may then explicitly encode the selected block sizes into the bitstream. Such massive search over each and every block size may render a highly complicated codec implementation. Moreover, explicitly coding block size information under-utilizes spatial correlation, which may reduce compression efficiency.

However, aspects of the disclosure use recursive block partitioning, which may allow for more flexibility in optimizing block size, while maintaining a relatively simple and concise codec implementation. In some implementations, recursive block partitioning translates coding of actual block sizes to coding of partition types (further described herein), which in conjunction with context-based entropy coding, provides improved performance gains. Flexibility in terms of allowable block sizes may improve compression efficiency by maintaining a simple and concise codec structure. Further, in some implementations, context-based entropy coding of the partition type may provide further coding performance gains. Aspects of the disclosure may be applied to research and development of video codecs and/or various video compression techniques (e.g., codec design). Still further, aspects of the disclosure may be applied and/or applicable to video streaming and/or still picture coding related techniques.

FIG. 3 is a block diagram illustrating an example decoder 300, in accordance with aspects of the disclosure. In some implementations, the decoder 300 may be similar to the reconstruction path 232 of the encoder 200. The decoder 300 may include one or more stages to perform various functions to provide an output video stream 342 from an encoded or compressed bitstream 310. The decoder 300 may include an entropy decoding stage 314, a dequantization stage 318, an inverse transform stage 322, a reconstruction stage 326, a loop filtering stage 330, an intra/inter prediction stage 334, and a deblocking filtering stage 338. In other implementations, structural variations of the decoder 300 may be used to decode the compressed bitstream 310.

When the compressed bitstream 310 is provided to the decoder 300 for decoding, the data elements within the compressed bitstream 310 may be decoded by the entropy decoding stage 314 (e.g., using VLC, arithmetic coding, etc.) to produce a set of quantized transform coefficients. The dequantization stage 318 may be configured to dequantize the quantized transform coefficients, and the inverse transform stage 322 may be configured to inverse transform the dequantized transform coefficients to provide a derivative residual that may be identical to that generated by the inverse transform stage 238 of the encoder 200. In some implementations, using header information decoded from the compressed bitstream 310, the decoder 300 may be configured to use the intra/inter prediction stage 334 to generate the same prediction block as was generated in the encoder 200 by the intra/inter prediction stage 214. At the reconstruction stage 326, the prediction block may be added to the derivative residual to generate a reconstructed block. The loop filtering stage 330 may be applied to the reconstructed block to reduce blocking artifacts. In some implementations, various other filtering may be applied to the reconstructed block. For instance, the deblocking filtering stage 338 may be applied to the reconstructed block to reduce blocking distortion resulting in output, e.g., as the output video stream 342. The output video stream 342 may be referred to as a decoded video stream or a decoded output video stream.

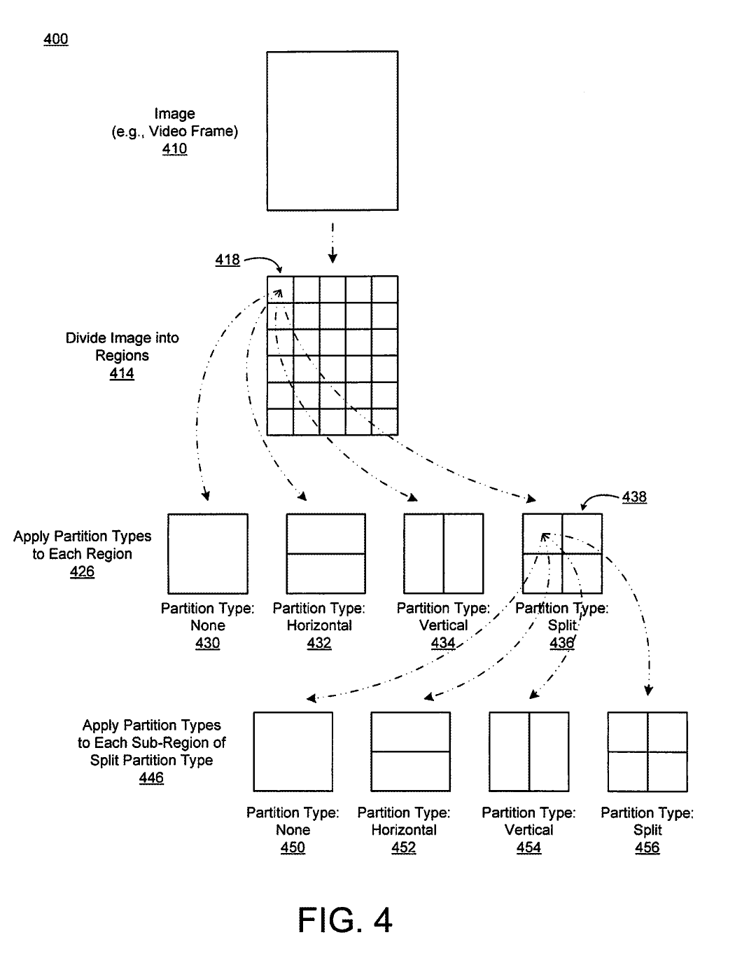

FIG. 4 is a block diagram illustrating an example technique for recursive block partitioning 400, in accordance with aspects of the disclosure. In FIG. 4, in some implementations, an image 410 (e.g., a video frame) may be divided into a plurality of regions 414, such as a grid of regions, where each region 418 may be at least smaller than the image itself (e.g., each region of size 64×64 pixels). In this instance, each region 418 may be tested with a rate distortion loop to evaluate and discover an optimal coding decision (including a manner of dividing or partitioning the image 410 into smaller block sizes, a prediction mode per block, a transform type applied to each block, etc.), and then coded into a bitstream in a raster order.

In reference to the optimal coding scheme, for a given region, the encoder may be configured to test one, some, or all possible partition (dividing) types, with each resulting in a set of sub-blocks that may be mutually exclusive and together may cover the entire region. The encoder may then test various possible coding modes, including prediction modes, reference sources, filter types, transform types and sizes, etc., on each sub-block, and obtain the one that minimizes a rate-distortion cost of this sub-block or that has a rate-distortion cost that satisfies a threshold condition (e.g., a threshold value). Each partition type of a given region may now be associated with a rate-distortion cost value, which may be calculated as a summation of a minimum rate-distortion cost of each sub-block. Hence, the encoder may choose or select a partition type that renders a minimum overall cost.

Unlike a conventional massive search over all possible block sizes, aspects of the disclosure may be configured for a recursive block partitioning approach for rate distortion search and encoding and decoding processes, as described herein. In various implementations, during a rate distortion optimization phase, each region 418 may be tested through a plurality of partition types 426, such as, for instance, at least one of four partition types including a no partition (none) partition type 430, a horizontal (horz) partition type 432, a vertical (vert) partition type 434, and split partition type 436, which divides each region 438 into four smaller regions (split) or sub-regions 438, which may be referred to as sub-blocks. As shown in FIG. 4, the resulting sub-regions 438 may then be independently tested over one or more possible prediction modes, filter types, transform sizes, etc., to find their (locally) optimal coding decisions. This refers to recursive partitioning of the image 410.

In some implementations, the partition operation may apply to square blocks. For instance, a region may include a size N×N, where N is an even number (e.g., a power of two). The four partition types may result in the following sub-block sizes:

NONE->one N×N sub-block,

SPLIT->four (N/2)×(N/2) sub-blocks,

VERTICAL->two (N/2)×N sub-blocks, and

HORIZONTAL->two N×(N/2) sub-blocks.

In some implementations, a first partition type may include the split partition type 436 having four sub-blocks of similar dimension, a second partition type may include the horizontal partition type 432 having two horizontally arranged sub-blocks of similar dimension, the third partition type may include a vertical partition type 434 having two vertically arranged sub-blocks of similar dimension, and a fourth partition type may include the no partition type 430 having a single block.

In some implementations, the partition types 426 including none 430, horz 432, and vert 434 may be considered end-nodes, i.e., where no further partitioning may be applied to the sub-block inside. Each sub-region 438 of the split partition type 436 may then be considered as a starting point that may be recursively tested through each of the four partition types 446, including none 430, horz 432, vert 434, and split 456. In this instance, each region 418 of the first division 414 may be divided into a plurality of sub-regions 438 in the second division 446, such as a grid of four regions. This recursive partitioning may be repeated any number of times for each iteration of the split partition type. In some implementations, this recursive partitioning may start with 64×64 pixel blocks with each next recursive partitioning following in a series of 32×32 pixel blocks, 16×16 pixel blocks, 8×8 pixel blocks, and 4×4 pixel blocks. In some implementations, from 4×4 pixel blocks, the recursive partitioning may follow next to 2×2 pixel blocks. In other implementations, the recursive partitioning may start with any n-x-n pixel blocks and end with any n-x-n pixel blocks. It should be understood that coding mode information (such as, e.g., reference frame index, filter types, etc.) may be optionally constrained to be assigned above a certain block size level.

Once optimal coding modes are selected, the encoder 200 may be configured to write them into the bitstream. Instead of explicitly coding the actual block sizes inside a given region, this recursive partitioning approach codes the partition type in a recursive manner. For instance, this recursive partitioning approach may start with a 64×64 block and writes the partition type. If this type is vert, horz, or none, the sub-block sizes may already be parsed, hence no further partition information is sent. If this type is split partition type, then the encoder 200 may write another four partition types, one for each sub-block. In some implementations, the encoder 200 repeats sending the partition type information, until reaching vert/horz/none partition types, or in some instances, below 8×8 block size, for example. The decoder 300 may be configured to start with a 64×64 block, read the partition type, and parse the sub-block sizes accordingly.

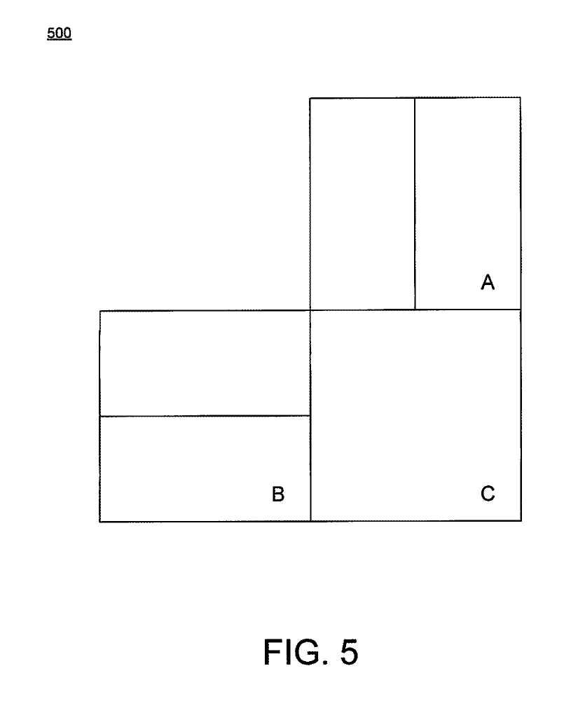

Further, aspects of the disclosure are configured to implement a context-based entropy coding approach to the partition information. For instance, probability models for the partition type coding may be conditioned on the following three factors: current block size (e.g., 64×64, 32×32, 16×16, etc.), the partition type of its above neighboring block, the partition type of its left neighboring block, as described in reference to FIG. 5. In some implementations, these conditional probability models may be configured as backward adaptive, and may be updated per-frame. Such a context-based entropy coding approach efficiently exploits spatial correlation, i.e., where the partition types tend to be consistent in consecutive areas, and this context-based entropy coding approach may achieve certain performance gains.

In some implementations, natural video signals may be viewed (modeled) as a stationary random process. A block may possess certain similarity to one or more nearby blocks, including pixel values, motion information, etc. For example, if a frame includes an object of dark color moving horizontally in front of a bright background, the blocks (regions) that include the object edges may tend to be vertically partitioned, so that sub-blocks that include the object and background, respectively, may be coded separately, which allows more flexibility in optimizing the coding modes of each.

In an implementation of FIG. 4, the system and methods of the disclosure may be configured to divide an image 410 (e.g., a video frame) into a plurality of regions 414, apply a plurality of partition types 426 to each region 418 of the plurality of regions, and determine a rate distortion cost for each region 418 based on the plurality of partition types 426 applied to each region 418. Further, the system and methods of the disclosure may be configured to determine a coding scheme for each region 418 based on the plurality of partition types 426 applied to each region 418, and separately encode each region 418 based on the rate distortion cost and the coding scheme determined for each region 418. In some implementations, this partitioning method may be recursively applied to one or more sub-regions 438 of at least one of the partition types 426, such as the split partition type 436, in a repeating manner to achieve optimal rate distortion cost. The rate distortion loop may be used for improving video quality in video compression and may involve comparing and determining an amount of distortion (loss of video quality) against an amount of data used to encode a video (data rate). In some examples, the rate distortion loop may be used to improve encoding where decisions may simultaneously affect a file size and quality of an encoded video.

FIG. 5 is a block diagram illustrating an example technique for context-based entropy encoding of partition type, in accordance with aspects of the disclosure. In some implementations, as described herein, the sample space of partition type may include at least 4 entries, including no partition (NONE), horizontal partition (HORZ), vertical partition (VERT), and split into 4 sub-blocks (SPLIT). Each square block of sizes ranging from, e.g., 8×8 to 64×64 may be assigned at least one partition type. This symbol may be coded using entropy coding that adopts a probability distribution over the sample space to achieve compression.

For instance, as shown in FIG. 5, blocks A and B may represent previously coded blocks, and block C may represent a block to be encoded. In reference to spatial consistency of natural video/image signals, if A is vertically partitioned (i.e., VERT or SPLIT), it is more likely that C may also be vertically partitioned. Similarly, if B is horizontally partitioned (i.e., HORZ, or SPLIT), it is highly possible that C may also be partitioned horizontally. Therefore, aspects of the disclosure provide a probability distribution used by an entropy coder dependent on the partition types of its above (i.e., A) and left coded neighbors (i.e., B) in FIG. 5. Further, aspects of the disclosure recognize a potential dependency of a probability model (distribution) on a block size of block C, e.g., a 64×64 block may be more likely to choose SPLIT than a 8×8 block, given a same above/left block partition types.

Therefore, this work employs an array of probability models to capture the above mentioned dependencies, as illustrated in FIG. 5. Further, this work computes an index number from the neighboring above/left block (A and B) partition types and the current block size, retrieves the corresponding probability model from the array, and uses the retrieved model for the entropy coding of the partition type of C.

The following is sample code for context-based entropy encoding of partition type:

source codes that retrieve the context information:

static INLINE intpartition_plane_context(MACROBLOCKD*xd,
BLOCK_SIZE_TYPE sb_type) {

intbsl=mi_width_log2(sb_type), bs=1<<bsl;

int above=0, left=0, i;

intboffset=mi_width_log2(BLOCK_SIZE_SB64×64)−bsl;

assert(mi_width_log2(sb_type)==mi_height_log2(sb_type));

assert(bsl>=0);

assert(boffset>=0);

for (i=0; i<bs; i++)
above |=(xd->above_seg_context[i] & (1<<boffset));

for (i=0; i<bs; i++)
left|=(xd->left_seg_context[i] & (1<<boffset));

above=(above>0);

left=(left>0);

return (left*2+above)+bsl*PARTITION_PLOFFSET;

}

In some implementations, in reference to the recursive block partitioning approach and its entropy coding in video compression, as described in reference to FIGS. 4-5, allowable block sizes may include various n-x-n pixel blocks, such as 8×8, 16×16, 32×32, 64×64, and as described herein, wherein each block size may be coded as one of the 4 partition types, {NONE, HORZ, VERT, SPLIT}.

At this point, in some implementations, possible outcomes may be either square or rectangular blocks. It is possible to skip any one or more partition types. For example, for a 32×32 block, the optimization process or technique may choose between either coding as one 32×32 block, or two 32×16 sub-blocks, and hence skip testing of other partition types to speed up the optimization process.

In some implementations, in reference to FIG. 5, the combination of partition types A and B may translate into an integer number ranging from 0 to 3, via the following rules:

if partition type of A is VERT or SPLIT, a=2; otherwise, a=0;

if partition type of B is HORZ or SPLIT, b=1; otherwise, b=0;

combining these two factors gives c=(a+b).

This number, c, is further offset according to the block size:

if block size is 8×8, offset=0;

if block size is 16×16, offset=4;

if block size is 32×32, offset=8;

if block size is 64×64, offset=12;

The overall index that may be used to retrieve the probability model from the array is calculated as (c+offset).

As described herein, context-based entropy coding may be applied to partition information, where probability models for partition type coding are conditioned on one or more of factors including current block size (e.g., 64×64, 32×32, 16×16, 8×8, etc.), partition type of its above block, and partition type of its left block. These conditional probability models may be considered backward adaptive and may be updated on a per-frame basis. This technique of context-based entropy coding may be used to efficiently exploit spatial correlation, where in come examples, partition types tend to be consistent in consecutive areas and may be used to achieve certain performance gains.

For instance, in some implementations, referring to FIG. 5, probability distribution may be considered dependent on the partition type of its above (a) coded neighbor (e.g., A) and its left (1) coded neighbor (e.g., B). Further, in some examples, potential dependency of a probability model (distribution) on a block size of block C, e.g., a 64×64 block may be more likely to choose SPLIT than a 8×8 block, given same above/left block partition types. Therefore, an array of probability models may be used to capture these potential dependencies, as shown in FIG. 5.

In some implementations, one or more probability tables may be generated to identify a probability distribution for a current block based on partition types of its above and left neighboring blocks. As such, aspects of the disclosure provide for building tables (e.g., probability tables (also can be referred to as probability distribution tables)) for context-based entropy coding of a current block based on partition types of neighboring blocks (e.g., above and left neighboring blocks).

In some implementations, a default probability table may be used for a first frame in a video sequence (which may be referred to as a sequence of video frames), and a probability table update may be applied to a next frame (which may be referred to as a subsequent frame) based on the probability distribution of partition types of the first frame. In some examples, the encoder 120 of FIGS. 1A and/or 1B may be used to generate probability distribution tables.

FIG. 1B is a diagram that illustrates example components associated with the computing device 104 shown in FIG. 1A. As shown in FIG. 1B, the memory 112 may be configured to store the probability table 160, and the encoder 120 may be configured to optimally encode each block in a video frame based on probability values stored in the probability table 160.

For instance, in reference to the examples of FIGS. 1B and 4, the encoder 120 may be configured to divide an image (e.g., a video frame) into a plurality of regions, apply a plurality of partition types (e.g., vertical horizontal, none, split) to each region of the plurality of regions, and determine an optimal rate distortion cost for each region based on the plurality of partition types applied to each region. Further, the encoder 120 may be configured to determine an optimal coding scheme for each region based on the plurality of partition types applied to each region, and separately encode each region based on the optimal rate distortion cost and the optimal coding scheme determined for each region.

In some implementations, this partitioning technique may be recursively applied to each region and sub-region of each partition type in a repeating manner to achieve optimal rate distortion cost. The rate distortion loop may be used for improving video quality in video compression and may involve comparing and determining an amount of distortion (loss of video quality) against an amount of data used to encode a video (data rate). In some examples, the rate distortion loop may be used to improve encoding where decisions may simultaneously affect a file size and quality of an encoded video.

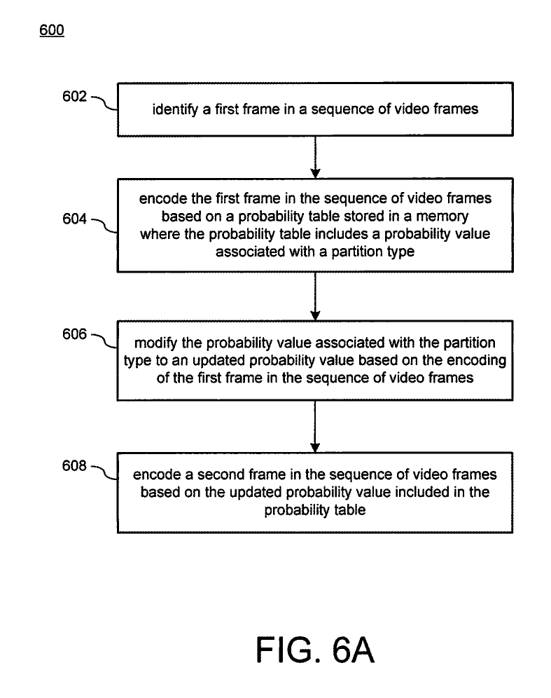

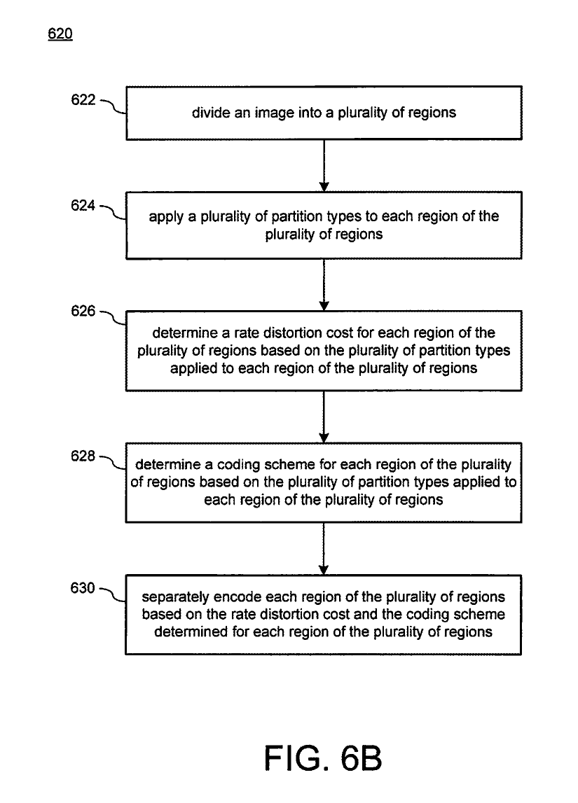

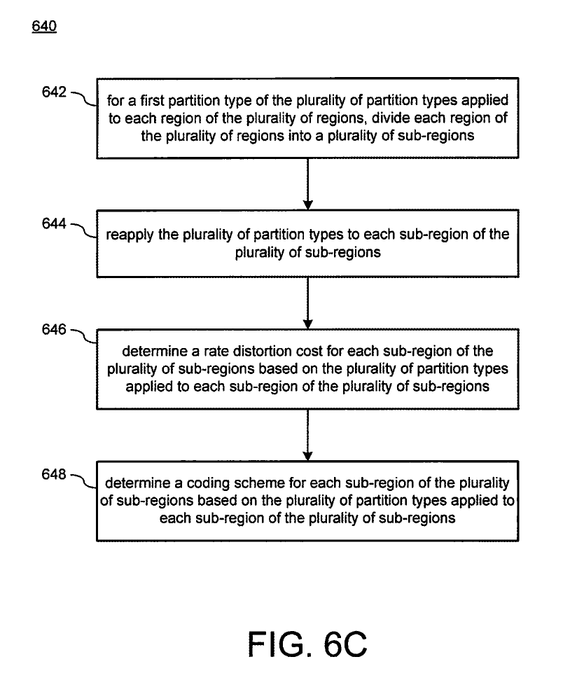

FIG. 6A is a flowchart illustrating a method 600 for producing probability tables at the encoder 120, in accordance with aspects of the disclosure. The encoder 120 may be configured to store one or more probability tables 160 in memory 112, including storing a default probability table in the memory 112 of the computing device 104.

In the example of FIG. 6A, operations 602-608 are illustrated as discrete operations occurring in sequential order. However, it should be appreciated that, in other implementations, two or more of the operations 602-608 may occur in a partially or completely overlapping or parallel manner, or in a nested or looped manner, or may occur in a different order than that shown. Further, additional operations, that may not be specifically illustrated in the example of FIG. 6A, may also be included in some example implementations, while, in other implementations, one or more of the operations 602-608 may be omitted. In some implementations, the method 600 may include a process flow for a computer-implemented method for recursive block partitioning in the system 100 of FIG. 1A. Further, as described herein, the operations 602-608 may provide a simplified operational process flow that may be enacted by the computing device 104 to provide features and functionalities as described in reference to FIG. 1A.

In the example of FIG. 6A, at 602, the method 600 may include identifying a first frame in a sequence of video frames. For instance, the encoder 120 may be configured to detect a new video sequence, reset/restart probability calculations, and update/modify probability tables including, e.g., reset probability tables to default at a beginning (first frame) of a video sequence. In some implementations, the encoder 120 may be configured to change probability distribution numbers and/or values when detecting a first frame of a video sequence.

At 604, the method 600 may include encoding the first frame in the sequence of video frames based on a probability table stored in a memory, where the probability table includes a probability value associated with a partition type. For instance, the encoder 120 may be configured to encode the first frame in the sequence of video frames based on at least one of the probability tables stored in memory. In some implementations, each probability table may include one or more probability values associated with one or more partition types. In some implementations, each frame may be recursively encoded to determine optimal coding decisions, including the manner in which each frame is partitioned into smaller block sizes, the prediction mode per block, the transform type applied to each block, etc.

At 606, the method 600 may include modifying the probability value associated with the partition type to an updated probability value based on the encoding of the first frame in the sequence of video frames. For instance, the encoder 120 may be configured to modify/update a probability value associated with a partition type to an updated probability value based on encoding of the first frame in the sequence of video frames. In some implementations, the probability values of each probability table may be modified/updated to optimize coding decisions for each frame in a video sequence.

At 608, the method 600 may include encoding a second frame in the sequence of video frames based on the updated probability value included in the probability table. For instance, the encoder 120 may be configured to encode a second frame in the sequence of video frames based on modified/updated probability values included in the probability table. As described herein, the memory 112 may include the probability table 160, with the probability table 160 including one or more probability values.

In accordance with aspects of the disclosure, the encoder 120 may be configured to utilize a context-based entropy coding approach to analyze neighboring blocks and select a partition type to optimize coding decisions. For instance, probability models for partition type coding may be conditioned on one or more of the following factors: a current block size (e.g., 64×64, 32×32, 16×16, 8×8, 4×4, 2×2, etc.), a partition type of an above neighboring block, and a partition type of a left neighboring block. Each conditional probability model may be backward adaptive and may be updated on a per-frame basis. This context-based entropy coding technique may be used to efficiently exploit spatial correlation, where partition types tend to be consistent in consecutive areas, and may be used to achieve various performance gains.

In reference to the example of FIG. 1A, the decoder 124 may include one or more stages to perform various functions to provide a output video stream decoded from an encoded or compressed bitstream. As described herein, an encoded bitstream may be provided to the decoder for decoding to provide a decoded output video stream, in accordance with aspects of the disclosure. In some implementations, the decoder 124 is a complement of the encoder 120, whereby a decoding process used by the decoder 124 is a complement of an encoding process used by the encoder 120, where the decoder 124 is configured to perform a decoding process in reverse of an encoding process as performed by the encoder 120.

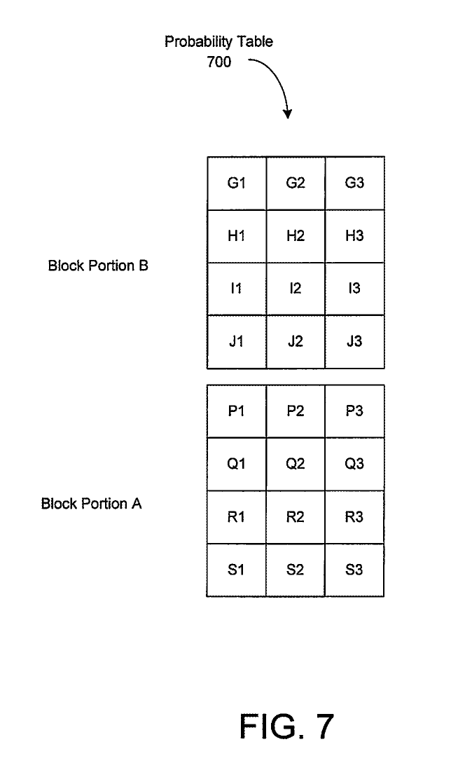

FIG. 7 is a diagram that illustrates an example of a probability table 700 according to an implementation. As shown in FIG. 7, the probability table 700 includes two different block portions—block portion B and block portion A. Each of the block portions is associated with a current block size that is being processed. For example, block portion A of the probability table 700 is used for making decisions related to a split of a block having block size A to block size B (e.g., 64×64 to 32×32). The block size A can be referred as the current block size being processed and the block size B can be referred to as the target block size. Block portion B of the probability table 700 is used for making decisions related to a split of a block having block size B to, for example, block size C (e.g., 32×32 to 16×16). Although not shown, additional block portions and/or sizes (including non-square sizes) can be included.

In this example, block portion A includes probability values on four rows and three columns. The four rows are delineated by characters P through S and the columns are delineated by the numbers 1 through 3. Accordingly, probability value Q2 is included on the second row and the second column.

Each of the rows P through S are associated with a different type of neighbor analysis. As a specific example, row P can include probability values for analysis of above and left neighbors (to the instant block being analyzed) that are both not split, and row Q can include probability values for analysis of an above neighbor that is split and a left neighbor that is not split. Accordingly, an encoder (e.g., encoder 120 shown in FIG. 1A) can be configured to select a row of probability values of the probability table 700 during analysis of a current block that corresponds with the splits (or non-split) of blocks neighboring (e.g., adjacent) blocks.

The probability values can represent values that can be used by an entropy coder. During encoding, the entropy coder can be configured to assign bit rates based on the probability values included in the probability table 700. Fewer bits can be assigned by an entropy coder to a relatively high outcome (e.g., relatively highly possible outcome, more likely outcome) as represented by a probability value, and a higher number of bits can be assigned by an entropy coder to a relatively unlikely outcome as represented by a probability value.

Each of the columns in the probability table 700 is associated with a different type of partition. For example, the probability value P1 (in row P) can represent a probability of no partitioning, the probability value P2 can represent a probability of a vertical split, and the probability value P3 can represent a probability of a horizontal split. If conditions for splitting associated with probability values P1 through P3 are not satisfied, then the result of the partition analysis is a different split (e.g., a complete four way split). In some implementations, the probability table 700 can include a fourth column that has a 100% probability and is associated with the final result if conditions associated with the first three columns of probability values (e.g., P1 through P3) are not satisfied.

In some implementations, the probability values can have a range of, for example, 0 to 255. The higher probabilities values can be a probability of the outcome associated with the probability value. For example, the probability value P2 can represent a probability of a vertical split, and the probability value P2 can be 245 on a scale of 0 to 255. Accordingly, the probability of a vertical split based on probability value P2 is very high.

In some implementations, the probability values included in the probability table 700 can be updated during processing of frames in a sequence of frames. For example, the probability table 700 can be a default probability table that can be used for an initial frame (e.g., a first frame) in a video sequence or sequence of frames. Depending on the outcome of splitting of blocks in the initial frame, the probability values included in the probability table 700 can be modified for encoding of a subsequent frame (e.g., second). As a specific example, the probability value P2 can represent a probability associated with a vertical split within a block of block size A to block size B. If the distribution of vertical splitting within a first frame from block size A to block size B is relatively high, the probability value P2 can be increased for processing of blocks for a second frame. If, on the other hand, the distribution of vertical splitting within a first frame from block size A to block size B is relatively low, the probability value P2 can be decreased for processing of blocks for a second frame.

In some implementations, changes to one or more of the probability values included in the probability table 700 can be stored as a difference (or residual) from default probability values included in the probability table 700. The difference can be stored and can be associated with the block or frame being processed. Accordingly, the difference can be used by a decoder (e.g., decoder 124 shown in FIG. 1A), in conjunction with default probability values, during decoding.

The modification of probability values can be performed with the processing of each frame (or group of blocks). In some implementations, default probability values can be used initially for the first frame in a sequence of video frames. For example, default probability values can be used for an I-frame and the probability values can be modified (from the default probability values) for each subsequent P-frame or B-frame processed after the I-frame. When a new I-frame (associated with a sequence of video frames (e.g., P-frames, B-frames) is reached, the default probability values can be re-instituted and used again for frames associated with the new I-frame.

The following is a specific example probability table (which can be default probability table) that may be generated to identify a probability distribution for a current block based on partition types of above and left neighboring blocks of the current block. The block size being processed and the target block size (e.g., II 8×8->4×4) are noted above the block portions of the table (which each include 4 rows and 3 columns). In this example, the ranges of the probability values are between 0 and 255. In some implementations, the ranges can be different.

```
// 8×8 -> 4×4
  { 199, 122, 141 }, // above/left both not split
  { 147, 63, 159 }, // above split, left not split
  { 148, 133, 118 }, // left split, above not split
  { 121, 104, 114 }, // above/left both split
// 16×16 -> 8×8
  { 174, 73, 87 }, // above/left both not split
  { 92, 41, 83 }, // above split, left not split
  { 82, 99, 50 }, // left split, above not split
  { 53, 39, 39 }, // above/left both split
// 32×32 -> 16×16
  { 177, 58, 59 }, // above/left both not split
  { 68, 26, 63 }, // above split, left not split
  { 52, 79, 25 }, // left split, above not split
  { 17, 14, 12 }, // above/left both split
// 64×64 -> 32×32
  { 222, 34, 30 }, // above/left both not split
  { 72, 16, 44 }, // above split, left not split
  { 58, 32, 12 }, // left split, above not split
  { 10,  7,  6 }, // above/left both split
```

In this example, the probability may be distributed between the values of 0-255, where a higher number may refer to a higher probability for a probable partition type for a current block based on a current block size (e.g., 64×64, 32×32, 16×16, etc.) of the current block, the partition type of its above neighboring block, and the partition type of its left neighboring block. In various examples, fewer bits may be assigned to likely candidates, and more bits may be assigned to non-likely candidates. Further, in some examples, the generated table may be applied to an entire frame.

In accordance with aspects of the disclosure, recursive block partitioning along with context-based entropy coding allows for improved flexibility when optimizing block size, while maintaining efficient video codec implementation. In various examples, this recursive block partitioning technique may be used to translate coding of actual block sizes to coding of block partition types, and in conjunction with context-based entropy coding, this technique provides improved coding performance gains.

FIGS. 6B-6C are process flows illustrating example methods for recursive block partitioning, in accordance with aspects of the disclosure. In particular, FIG. 6B is a process flow illustrating an example method 620 for recursive block partitioning, in accordance with aspects of the disclosure.

In the example of FIG. 6B, operations 622-628 are illustrated as discrete operations occurring in sequential order. However, it should be appreciated that, in other implementations, two or more of the operations 622-628 may occur in a partially or completely overlapping or parallel manner, or in a nested or looped manner, or may occur in a different order than that shown. Further, additional operations, that may not be specifically illustrated in the example of FIG. 6B, may also be included in some example implementations, while, in other implementations, one or more of the operations 622-628 may be omitted. Further, in some implementations, the method 620 may include a process flow for a computer-implemented method for recursive block partitioning in the system 100 of FIGS. 1. Further, as described herein, the operations 622-628 may provide a simplified operational process flow that may be enacted by the computing device 104 to provide features and functionalities as described in reference to FIG. 1A.

In the example of FIG. 6B, at 622, the method 620 may include dividing an image into a plurality of regions. At 624, the method 620 may include applying a plurality of partition types to each region of the plurality of regions. At 626, the method 620 may include determining a rate distortion (e.g., rate distortion cost) for each region of the plurality of regions based on the plurality of partition types applied to each region of the plurality of regions.

At 628, the method 620 may include determining a coding scheme for each region of the plurality of regions based on the plurality of partition types applied to each region of the plurality of regions. At 630, the method 620 may include separately encoding each region of the plurality of regions based on the rate distortion cost and the coding scheme determined for each region of the plurality of regions.

In some implementations, a first partition type may include a split partition type having four sub-blocks of similar dimension, a second partition type may include a horizontal partition type having two horizontally arranged sub-blocks of similar dimension, a third partition type may include a vertical partition type having two vertically arranged sub-blocks of similar dimension, and a fourth partition type may include a no partition type having a single block.

FIG. 6C is a process flow illustrating another example method 640 for recursive block partitioning, in accordance with aspects of the disclosure.

In the example of FIG. 6C, operations 642-648 are illustrated as discrete operations occurring in sequential order. However, it should be appreciated that, in other implementations, two or more of the operations 642-648 may occur in a partially or completely overlapping or parallel manner, or in a nested or looped manner, or may occur in a different order than that shown. Further, additional operations, that may not be specifically illustrated in the example of FIG. 6C, may also be included in some example implementations, while, in other implementations, one or more of the operations 642-648 may be omitted. Further, in some implementations, the method 640 may include a process flow for a computer-implemented method for recursive block partitioning in the system 100 of FIGS. 1. Further, as described herein, the operations 642-648 may provide a simplified operational process flow that may be enacted by the computing device 104 to provide features and functionalities as described in reference to FIG. 1A. Still further, the operations 642-648 may be a continuation of the operations 622-630 of FIG. 6B to provide a simplified operational process flow that may be enacted by the computing device 104 to provide features and functionalities as described in reference to FIG. 1A.

In the example of FIG. 6B, at 642, the method 640 may include, for a first partition type of the plurality of partition types applied to each region of the plurality of regions, dividing each region of the plurality of regions into a plurality of sub-regions. At 644, the method 640 may include reapplying the plurality of partition types to each sub-region of the plurality of sub-regions.

At 646, the method 640 may include determining a rate distortion cost for each sub-region of the plurality of sub-regions based on the plurality of partition types applied to each sub-region of the plurality of sub-regions. At 648, the method 640 may include determining a coding scheme for each sub-region of the plurality of sub-regions based on the plurality of partition types applied to each sub-region of the plurality of sub-regions.

In some implementations, a first partition type may include a split partition type having four sub-blocks of similar dimension, a second partition type may include a horizontal partition type having two horizontally arranged sub-blocks of similar dimension, a third partition type may include a vertical partition type having two vertically arranged sub-blocks of similar dimension, and a fourth partition type may include a no partition type having a single block.

In some implementations, separately encoding each region of the plurality of regions based on the rate distortion cost and the coding scheme determined for each region of the plurality of regions may include separately encoding each sub-region of the plurality of sub-regions based on the rate distortion cost and the coding scheme determined for each sub-region of the plurality of sub-regions.

In some implementations, determining a rate distortion cost for each region of the plurality of regions may include evaluating a plurality of rate distortion costs for each region of the plurality of regions based on the plurality of partition types applied to each region of the plurality of regions and determining an optimal rate distortion cost for each region of the plurality of regions, the optimal rate distortion cost selected from the plurality of rate distortion costs evaluated for each region of the plurality of regions.

In some implementations, determining a coding scheme for each region of the plurality of regions may include evaluating a plurality of coding schemes for each region of the plurality of regions based on the plurality of partition types applied to each region of the plurality of regions and determining a coding scheme for each region of the plurality of regions, the optimal coding scheme selected from the plurality of coding schemes evaluated for each region of the plurality of regions.

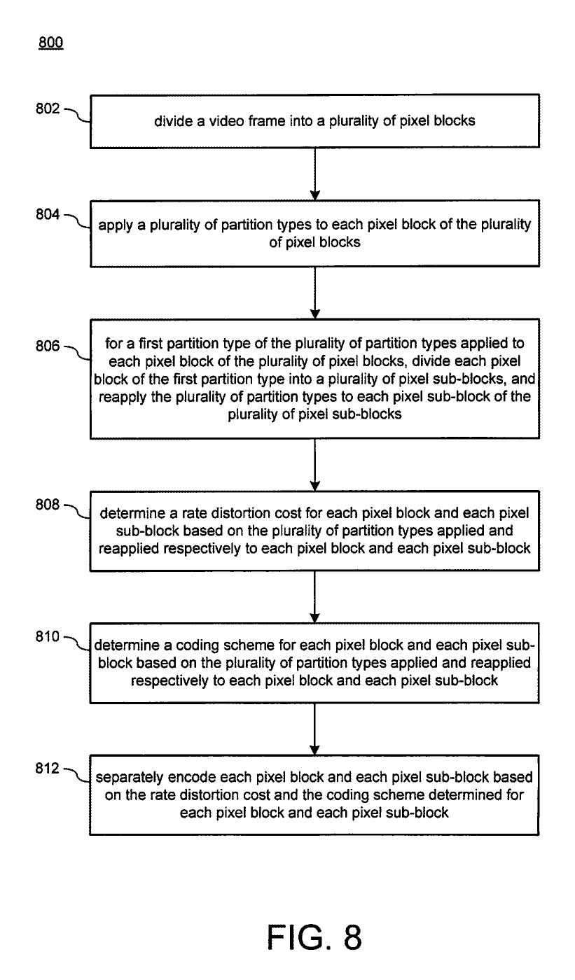

FIG. 8 is a process flow illustrating another example method 800 for recursive block partitioning, in accordance with aspects of the disclosure.

In the example of FIG. 8, operations 802-808 are illustrated as discrete operations occurring in sequential order. However, it should be appreciated that, in other implementations, two or more of the operations 802-808 may occur in a partially or completely overlapping or parallel manner, or in a nested or looped manner, or may occur in a different order than that shown. Further, additional operations, that may not be specifically illustrated in the example of FIG. 8, may also be included in some example implementations, while, in other implementations, one or more of the operations 802-808 may be omitted. Further, in some implementations, the method 800 may include a process flow for a computer-implemented method for recursive block partitioning in the system 100 of FIG. 1. Further, as described herein, the operations 802-808 may provide a simplified operational process flow that may be enacted by the computing device 104 to provide features and functionalities as described in reference to FIG. 1A.

In the example of FIG. 8, at 802, the method 800 may include dividing a video frame into a plurality of pixel blocks. At 804, the method 800 may include applying a plurality of partition types to each pixel block of the plurality of pixel blocks.

At 806, the method 800 may include, for a first partition type of the plurality of partition types applied to each pixel block of the plurality of pixel blocks, dividing each pixel block of the first partition type into a plurality of pixel sub-blocks, and reapply the plurality of partition types to each pixel sub-block of the plurality of pixel sub-blocks. At 808, the method 800 may include determining a rate distortion cost for each pixel block and each pixel sub-block based on the plurality of partition types applied and reapplied respectively to each pixel block and each pixel sub-block.

At 810, the method 800 may include determining a coding scheme for each pixel block and each pixel sub-block based on the plurality of partition types applied and reapplied respectively to each pixel block and each pixel sub-block. At 812, the method 800 may include separately encoding each pixel block and each pixel sub-block based on the rate distortion cost and the coding scheme determined for each pixel block and each pixel sub-block.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, may be written in any form of programming language, including compiled or interpreted languages, and may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for user interaction, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other types of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of networks, such as communication networks, may include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A non-transitory computer-readable storage medium storing instructions that when executed cause at least one processor to perform a process, the instructions comprising instructions configured to:
divide an image into a plurality of regions;
apply a plurality of partition types to each region of the plurality of regions based on a probability table;
determine a rate distortion cost for each region of the plurality of regions based on the plurality of partition types applied to each region of the plurality of regions;
determine a coding scheme for each region of the plurality of regions based on the plurality of partition types applied to each region of the plurality of regions; and
separately encode each region of the plurality of regions based on the rate distortion cost and the coding scheme determined for each region of the plurality of regions.

2. The computer-readable storage medium of claim 1, wherein the image includes a video frame, and the plurality of regions includes a grid of the plurality of regions.

3. The computer-readable storage medium of claim 1, wherein each region of the plurality of regions includes a block of n-by-n pixels.

4. The computer-readable storage medium of claim 3, wherein the block of n-by-n pixels includes at least one of a block of 64×64 pixels, a block of 32×32 pixels, a block of 16×16 pixels, a block of 8×8 pixels, a block of 4×4 pixels, and a block of 2×2 pixels.

5. The computer-readable storage medium of claim 1, wherein the probability table includes a probability value associated with a first partition type from the plurality of partition types and a probability value associated with a second partition type from the plurality of partition types.

6. The computer-readable storage medium of claim 1, wherein the plurality of partition types includes:
a first partition type including a split partition type having four sub-blocks of similar dimension,
a second partition type including a horizontal partition type having two horizontally arranged sub-blocks of similar dimension,
a third partition type including a vertical partition type having two vertically arranged sub-blocks of similar dimension, and
a fourth partition type including a no partition type having a single block.

7. The computer-readable storage medium of claim 1, wherein for a first partition type of the plurality of partition types applied to each region of the plurality of regions, the instructions include instructions configured to:
divide each region of the plurality of regions into a plurality of sub-regions;
reapply the plurality of partition types to each sub-region of the plurality of sub-regions;
determine a rate distortion cost for each sub-region of the plurality of sub-regions based on the plurality of partition types applied to each sub-region of the plurality of sub-regions; and
determine a coding scheme for each sub-region of the plurality of sub-regions based on the plurality of partition types applied to each sub-region of the plurality of sub-regions.

8. The computer-readable storage medium of claim 6, wherein the first partition type of the plurality of partition types includes a split partition type having four sub-blocks of similar dimension.

9. The computer-readable storage medium of claim 6, wherein the instructions configured to separately encode each region of the plurality of regions based on the rate distortion cost and the coding scheme determined for each region of the plurality of regions include instructions configured to:
separately encode each sub-region of the plurality of sub-regions based on the rate distortion cost and the coding scheme determined for each sub-region of the plurality of sub-regions.

10. The computer-readable storage medium of claim 1, wherein the instructions configured to determine a rate distortion cost for each region of the plurality of regions include instructions configured to:
evaluate a plurality of rate distortion costs for each region of the plurality of regions based on the plurality of partition types applied to each region of the plurality of regions; and
determine a rate distortion cost for each region of the plurality of regions, the rate distortion cost selected from the plurality of rate distortion costs evaluated for each region of the plurality of regions.

11. The computer-readable storage medium of claim 9, wherein the instructions configured to separately encode each region of the plurality of regions include instructions configured to:
separately encode each region of the plurality of regions based on the optimal rate distortion cost determined for each region of the plurality of regions.

12. The computer-readable storage medium of claim 1, wherein the instructions configured to determine a coding scheme for each region of the plurality of regions include instructions configured to:
evaluate a plurality of coding schemes for each region of the plurality of regions based on the plurality of partition types applied to each region of the plurality of regions; and
determine a coding scheme for each region of the plurality of regions, the optimal coding scheme selected from the plurality of coding schemes evaluated for each region of the plurality of regions.

13. The computer-readable storage medium of claim 11, wherein the instructions configured to separately encode each region of the plurality of regions include instructions configured to:
separately encode each region of the plurality of regions based on the optimal coding scheme determined for each region of the plurality of regions.

14. The computer-readable storage medium of claim 1, wherein the coding scheme includes a context-based entropy coding scheme that considers a size of each region, a partition type applied to a first neighboring region above each region, and a second neighboring region left of each region when determining the coding scheme for each region of the plurality of regions.

15. The computer-readable storage medium of claim 1, wherein the instructions configured to separately encode each region of the plurality of regions include instructions configured to:
separately encode each region into a bitstream in raster order based on the rate distortion cost and the coding scheme determined for each region of the plurality of regions.

16. A non-transitory computer-readable storage medium storing instructions that when executed cause at least one processor to perform a process, the instructions comprising instructions configured to:
divide a video frame into a plurality of pixel blocks;
apply a plurality of partition types to each pixel block of the plurality of pixel blocks based on a probability table;
for a first partition type of the plurality of partition types applied to each pixel block of the plurality of pixel blocks, divide each pixel block of the first partition type into a plurality of pixel sub-blocks, and reapply the plurality of partition types to each pixel sub-block of the plurality of pixel sub-blocks;
determine a rate distortion cost for each pixel block and each pixel sub-block based on the plurality of partition types applied and reapplied respectively to each pixel block and each pixel sub-block;
determine a coding scheme for each pixel block and each pixel sub-block based on the plurality of partition types applied and reapplied respectively to each pixel block and each pixel sub-block; and
separately encode each pixel block and each pixel sub-block based on the rate distortion cost and the coding scheme determined for each pixel block and each pixel sub-block.

17. The computer-readable storage medium of claim 16, wherein:
each pixel block includes a block of n-by-n pixels, and
each block of n-by-n pixels includes at least one of a block of 64×64 pixels, a block of 32×32 pixels, a block of 16×16 pixels, a block of 8×8 pixels, a block of 4×4 pixels, and a block of 2×2 pixels.

18. The computer-readable storage medium of claim 16, wherein:
the first partition type of the plurality of partition types includes a split partition type having four sub-blocks of similar dimension,
a second partition type including a horizontal partition type having two horizontally arranged sub-blocks of similar dimension,
a third partition type including a vertical partition type having two vertically arranged sub-blocks of similar dimension, and
a fourth partition type including a no partition type having a single block.

19. The computer-readable storage medium of claim 16, wherein the coding scheme includes a context-based entropy coding scheme that considers a size of each pixel block, a partition type applied to a first neighboring region above each pixel block, and a second neighboring region left of each pixel block when determining the coding scheme for each pixel block of the plurality of pixel blocks.

20. The computer-readable storage medium of claim 16, wherein the coding scheme includes a context-based entropy coding scheme that considers a size of each pixel sub-block, a partition type applied to a first neighboring region above each pixel sub-block, and a second neighboring region left of each pixel sub-block when determining the coding scheme for each pixel sub-block of the plurality of pixel sub-blocks.

21. A system comprising:
at least one processor and memory;
at least one processor configured to:
divide a frame into a plurality of regions;
apply a plurality of partition types to each region of the plurality of regions;
for at least one partition type of the plurality of partition types applied to each region of the plurality of regions, divide each region of the at least one partition type into a plurality of sub-regions based on a probability table, and reapply the plurality of partition types to each sub-region of the plurality of sub-regions;
determine a rate distortion cost for each region and each sub-region based on the plurality of partition types applied and reapplied respectively to each region and each sub-region;
determine a coding scheme for each region and each sub-region based on the plurality of partition types applied and reapplied respectively to each region and each sub-region; and
separately encode each region and each sub-region based on the rate distortion cost and the coding scheme determined for each region and each sub-region.

22. The system of claim 21, wherein the frame is a first frame, the probability table includes a probability value associated with the at least one partition type,
the at least one processor configured to update the probability value for processing of a second frame based on the processing associated with the first frame.

23. The system of claim 21, wherein the frame is a first frame in a sequence of video frames, the probability table includes a default probability value associated with the at least one partition type.

24. A non-transitory computer-readable storage medium storing instructions that when executed cause at least one processor to perform a process, the instructions comprising instructions configured to:
identify a first frame in a sequence of video frames;
encode the first frame in the sequence of video frames based on a probability table stored in a memory, the probability table including a probability value associated with a partition type;
modify the probability value associated with the partition type to an updated probability value based on the encoding of the first frame in the sequence of video frames; and
encode a second frame in a sequence of video frames based on the updated probability value included in the probability table.

25. The computer-readable storage medium of claim 24, wherein the encoding of the first frame includes entropy encoding.

26. The computer-readable storage medium of claim 24, wherein the instructions further comprising instructions to:
calculate a probability distribution of the partition type associated with the first frame, the modifying includes modifying based on probability distribution of the partition type.

27. The computer-readable storage medium of claim 24, wherein a bit rate associated with an entropy encoder is assigned based on the probability value.

28. The computer-readable storage medium of claim 24, wherein the probability table includes a first block portion associated with partitioning from a first block size to a second block size, and the probability table includes a second block portion associated with partitioning from the second block size to a third block size.
